(19) United States
(12) Patent Application Publication
(10) Pub. No.: US 2018/0139982 A1
(43) Pub. Date: May 24, 2018

(54) ICE CREAM WITH SUGAR CONE CRUNCHY BITS

(71) Applicant: ROGER FORD, LIVONIA, MI (US)

(72) Inventor: ROGER FORD, LIVONIA, MI (US)

(21) Appl. No.: 15/358,618

(22) Filed: Nov. 22, 2016

(51) Int. Cl. A23G 9/00

(52) U.S. Cl. CPC A23G 9/00

(57) ABSTRACT

A crunchy ice cream mix, including flavored ice cream and sugar cone bits for providing crunchy texture to the flavored ice cream. The sugar cone bits further include floor; sugar; baking powder; egg; butter; vanilla extract and lemon extract.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

### (1) Field of the Invention

The present invention relates to an ice cream mix. Particularly, the present invention relates to a flavored ice cream mix. More particularly, the present invention relates to a flavored ice cream mix with sugar cone crunchy bits.

### (2) Background of the Invention

The ice cream has been popular and enduring dessert items for generations. In their typical form, an ice cream mix is available in various flavors with smooth texture. Few example, in the prior art, there is provided the following patents that are herein incorporated by reference for their supportive teachings, and include the following: U.S. Pat. No. 2,279,203 A, U.S. Pat. No. 2,343,767 A and U.S. Pat. No. 2,070,455 A.

U.S. Pat. No. 2,279,203 A issued to MUSHER CORP. shows a frozen confection mixture and it is particularly directed to an Ice cream mixture. In the preparation of ice cream it is desirable that the ice cream, for many purposes, should have a true butter flavor.

U.S. Pat. No. 2,343,767 A issued to AERATION PROCESSES INC shows an ice cream and ice cream making and is herein disclosed in some detail as embodied in a commercial ice cream, although the procedure is well adapted for making ice cream in homes equipped with an electrical or gas refrigerator.

U.S. Pat. No. 2,070,455 A issued to Spalding, Clarence G. shows an improvements in the manufacture of ice cream, and includes an improved ice cream product, and an improved method of manufacture. Ice cream is a concentrated food product. Its main constituents, i. e. fats, milk, proteins and sugar.

None of the above listed prior art suggests a flavored ice cream with crunchy texture either independently or in combination.

### SUMMARY OF THE INVENTION

The present invention provides a new flavored ice cream mix with a crunchy texture.

Briefly, the present invention provides a crunchy ice cream mix, including flavored ice cream and sugar cone bits for providing crunchy texture to the flavored ice cream.

The primary objective of the present invention is to provide a flavored ice cream with crunchy texture.

Another objective of the present invention is to provide sugar cone crunch bits for ice cream mix.

These with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

Additional features and advantages of the invention will be set forth in the detailed description which follows, and in part will be readily apparent to those skilled in the art from that description or recognized by practicing the invention as described herein, including the detailed description which follows, the claims.

### DETAILED DESCRIPTION OF THE INVENTION

In the following detailed description, the illustrative specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The present invention generally provides a crunchy ice cream mix, including flavored ice cream and sugar cone bits for providing crunchy texture to the flavored ice cream. The sugar cone bits further include floor, sugar, baking powder, egg, butter, vanilla extract and lemon extract.

In an embodiment, the present invention provides the crunchy ice cream mix wherein the flavor of the ice cream mix is selected from the group of Vanilla, Chocolate, Strawberry and combination thereof. Also in this particular embodiment of the present invention the sugar used is brown sugar.

In one of the most preferred embodiment of the present invention, there is provided the crunchy Chocolate ice cream mix, including sugar cone bits made of flour, sugar, baking powder, egg, butter, vanilla extract and lemon extract. In this particular embodiment of the present invention the concentration of flour is 33.0% w/v, the concentration of the sugar is 27.0% w/v, wherein the concentration of the baking powder is 1.5% w/v, the concentration of the egg is 14.0% w/v, the concentration of the butter is 20.0% w/v, the concentration of the Vanilla extract is 3.0% w/v and the concentration of the Lemon extract is 1.5% w/v. Also, in this particular embodiment of the present invention the sugar cone bits are baked at 400° C. for 3 minutes.

It is to be understood that the above description is intended to be illustrative, and not restrictive. For example, the above-discussed embodiments may be used in combination with each other. Many other embodiments will be apparent to those of skill in the art upon reviewing the above description.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A crunchy ice cream mix comprising:
a) flavored ice cream; and
b) sugar cone bits for providing crunchy texture to the flavored ice cream.

2. The crunchy ice cream mix according to the claim 1, wherein the flavored ice cream is selected from a group of Vanilla, Chocolate, Strawberry and combination thereof.

3. The crunchy ice cream mix according to the claim 1, wherein the sugar cone bite further comprises of flour; sugar; baking powder; egg; butter;
vanilla extract and lemon extract.

4. The crunchy ice cream mix according to the claim 3, wherein the concentration of the flour is 33.0% w/v.

5. The crunchy ice cream mix according to the claim 3, wherein the concentration of the sugar is 27.0% w/v.

6. The crunchy ice cream mix according to the claim 3, wherein the concentration of the baking powder is 1.5% w/v.

7. The crunchy ice cream mix according to the claim 3, wherein the concentration of the egg is 14.0% w/v.

8. The crunchy ice cream mix according to the claim 3, wherein the concentration of the butter is 20.0% w/v.

9. The crunchy ice cream mix according to the claim 3, wherein the concentration of the Vanilla extract is 3.0% w/v.

10. The crunchy ice cream mix according to the claim 3, wherein the concentration of the Lemon extract is 1.5% w/v.

11. The crunchy ice cream mix according to the claim 1, wherein the sugar cone bits are baked at 400° C. for 3 minutes.
